(19) United States
(12) Patent Application Publication
(10) Pub. No.: US 2008/0276380 A1
(43) Pub. Date: Nov. 13, 2008

(54) Methods for Treating a Laundry Item

(75) Inventors: Mattia De Dominicis, Montvale, NJ (US); Lucia Rossi, Mira (IT); Roberto Vanin, Mira (IT); Giorgio Franzolin, Mira (IT)

Correspondence Address: NORRIS, MCLAUGHLIN & MARCUS, 875 THIRD AVE, 18TH FLOOR, NEW YORK, NY, 10022, US

(73) Assignee: RECKITT BENCKISER N.V., Hoofddorp (NL)

(21) Appl. No.: 11/910,840

(22) PCT Filed: Apr. 13, 2006
(86) PCT No.: PCT/GB06/01360

§ 371 Date: Nov. 6, 2007

(30) Foreign Application Priority Data
Apr. 15, 2005 (EP) 0525346.1

(51) Int. Cl. D06B 5/12; C11D 17/04; C11D 3/39; C11D 3/395

(52) U.S. Cl. 8/137; 510/283

(57) ABSTRACT

A process for treating a soil on a laundry item before it is washed, which comprises contacting the soil with a laundry cleaning product having an enclosing wall and containing a composition in the form of a powder, said composition comprising an active agent selected from the group consisting of a surfactant, a bleach or a mixture thereof, the wall being permeable to water and to components dissolved therein.

The present invention relates to a process for treating a soil on laundry. The present invention also relates to a multi-purpose product for treating a soil on laundry.

Laundry cleaning products are extremely well known. Usually a composition in the form of a liquid or powder is added to a laundry washing machine, either directly to the drum or via a dispenser, and washing is carried out using an appropriate selection from a number of pre-programmed cycles. Accurate dosing may be a problem, particularly when consumers do not read or follow the dosing instructions. Recently products in the form of laundry compositions packaged in a film of water-soluble polymer have become available.

Compositions for pretreating a laundry item, for example to remove a soil or to assist in soil removal, are also known. Such compositions are, for example, in the form of a liquid composition which may be applied directly to the item or by a spray device.

We have discovered a process for pretreating a laundry item which does not require a separate composition apart from the composition used in the main wash. Such a process has a considerable advantage in that multiple compositions are not required. This leads to savings in storage space and a simpler process.

The present invention provides a process for treating a soil on a laundry item before it is washed, which comprises contacting the soil with a laundry cleaning product having an enclosing wall and containing a cleaning composition, preferably in the form of a powder, said cleaning composition comprising an active agent selected from the group consisting of surfactants, bleaches, or mixture thereof, the wall being permeable to water and to components dissolved therein. The laundry cleaning product may also contain a binder, which glues or adheres the cleaning composition to the enclosing wall to retain the product until it is used.

The process of the present invention may further comprise adding the laundry cleaning product and laundry comprising the laundry item and optionally further laundry to a washing machine and conducting the wash.

The laundry cleaning product used in the process of the present invention may be used in a number of different ways. For example, one possibility is to add the product directly to the drum of washing machine as a pre-dosed additive. Alternatively, the product can be added to a bucket with water and laundry. The laundry item(s) may be allowed to soak for a predetermined period of time and then removed and, optionally, rinsed and/or washed in the usual manner. The product used in the process of the present invention therefore provides a multipurpose pre-dosed product which can be applied directly to soils, used as a wash additive and/or as a soaking agent.

The laundry cleaning product used in the process of the present invention is designed such that some cleaning agent is released (ideally less than 50% wt, 40% wt, 30% wt, 25% wt, 20% wt, and greater than 1% wt, 5% wt, 10% wt and 15% wt) when the product is initially contacted with a soil on an item to be pretreated. Most or all of the remaining cleaning agent is released over a period of time when exposed to water in the laundry washing machine.

One advantage of the process of the present invention is that discrete dosing is easily achieved and that the dosage may be varied without need of a measuring system, as would be required for a liquid or loose powder. If greater cleaning is required more than one dose may be used at a time.

A further advantage is that the same product may be used both for the pretreatment and for the main wash. This may result in a saving of time for a consumer carrying out both processes. It may also result in a decrease in the number of different cleaning products required by a consumer. Furthermore some consumers may have a belief that a separate pretreatment composition is too harsh or environmentally unfriendly. By making it clear to the consumer that the pretreatment product is the same as the main product, the consumer's fears are reduced.

A yet further advantage is that the cleaning product of the present invention will not deteriorate before use. Even if a small amount of water is spilled onto the product the outer wall will not dissolve.

A further advantage is that the product provides a surface which is easy, preferably, easy to wet because it, preferably, has a hydrophilic chemical treatment, and which can be used by the consumer to provide rubbing of the cleaning product being released from the product on the soil present on the fabric, thus increasing the performance of the product.

A further advantage is that the contents retained in the product or the enclosing walls of the product may comprise soil catching agents that trap soil inside or onto the product and, therefore, do not allow said soil to be available for subsequent redeposition onto the fabric.

The cleaning product has an enclosing wall which is permeable to water and to components dissolved therein. However, the wall may be impermeable to a powder held within the product.

By water permeable we mean having a water permeability of at least 10001/m²/s at 100 Pa according to DIN EN ISO 9237. In addition the wall must not be so permeable that it is not able to hold the powder composition. Thus, for example, the wall may have a mesh size of less than 250 microns, preferably less than 150 microns, more preferably less than 50 microns.

The cleaning product may optionally have an enclosing wall portion which is insoluble and permeable to water, allowing the dissolution of active ingredients, and another enclosing wall portion which is insoluble and impermeable to water. This two different functional wall system is useful for direct soil treatment because the side permeable to water can be used for soil direct treatment, whereas the other side impermeable to water can be used for handling the product. Specifically, the impermeable wall portion or side prevents a user's hands from coming into contact with the cleaning composition contained within the enclosing wall.

The closed product must resist a laundry wash cycle (2 h wash/rinse/spin cycle, 95° C., spinning at 1600 rpm) without opening.

The cleaning composition is, preferably in the form of a powder. By “powder” we mean any solid, flowable composition. Thus the powder may, for example, be in the form of granules or agglomerated particles. The cleaning composition may, however, be in the form of a tablet wherein a powder has been compressed. It may, however, be in the form of a loose agglomeration of particles, having a d₅₀ particle size ranging from 0.01 mm to 10 mm, preferably between 1 mm and 2 mm. The d₅₀ particle size is the particle size or weight median particle diameter which 50% wt of the particles are larger than, and 50% wt of the particles are small than. It may suitably be determined by mechanical sieving.

The product must be able to pretreat a laundry item. Thus during some of the pretreatment process some of the cleaning composition held within the product contacts the soil on the laundry item. If desired the laundry item may be dry or wet. The product may also be moistened if desired to assist the cleaning composition to contact the soil. The product may be pre-moistened by the manufacturer, or may be moistened by the consumer, for example by holding it under a running tap of water or by dipping it in a quantity of water for a suitable duration.

The product should not be able to move out of the drum of a laundry washing machine, such as by entering the internal pipework of the washing machine and onto the filter. Thus if it is intended to be added direct to the drum it is generally large, preferably having a minimum length and width of at least 120 mm.

The product is preferably flat i.e. its thickness is preferably at least 5 times less, preferably at least 10 times less, ideally at least 30 times less, than the other two dimensions, its width and the length (which are the same as each other when the product is square or circular in plan).

The product can be also contained inside a cellular plastic material, having a thickness below 5 cm, preferably below 2 cm and more preferably below 1 cm.

The product is generally discarded after use.

The product may be placed with the laundry to be washed in an automatic laundry washing machine. Alternatively the product may be packed into the flow pathway for the rinse or wash water of a laundry washing machine such that the water is compelled to flow through it.

Preferably the product is formed into a flat container or a sachet from a sandwich of two webs. A water permeable sheet or film is present in one of the webs, at least, and forms at least one wall of the container. The water-permeable outer wall may comprise, for example, a woven, knitted or preferably non-woven material, of textile, polymer or paper. The material may be in the form of single layer or laminated layers. Preferably the wall comprises a sheet with a ply of one, two or three layers, such that any non-dissolved or insoluble agent inside the container is too large to pass through the perforation(s) or would have to follow an impossibly tortuous pathway if it were to exit the container through the wall. Preferably the sheet is a woven or non-woven material.

The product may conveniently comprise two webs sealed together about their periphery, with the contents held inside. The sealing may be by means of adhesive or dielectric welding or, preferably, heat sealing or, most preferably, ultrasound sealing. When the sealing is by heat sealing the sheets may comprise a thermoplastic to facilitate this. The material forming the adhesive strips can be a so called hot melt comprising various materials, such as APP, SBS, SEBS, SIS, EVA and the like, or a cold glue, such as a dispersion of various materials, e.g. SBS, natural rubber and the like, or even a solvent-based or a two-component adhesive system. Furthermore, the material may be capable of crosslinking to form specific, permanent chemical bonds with the various layers. The amount of adhesive is a function of the type of adhesive used. However it is generally from 0.2 to 20 g/m².

Conventional materials used in tea bag manufacture or in the manufacture of sanitary or diaper products may be suitable, and the techniques used in making tea bags or sanitary products can be applied to make flexible products useful in this invention. Such techniques are described in

WO 98/36128, U.S. Pat. No. 6,093,474, EP-A-708,628 and EP-A-380,127. U.S. Pat. No. 5,053,270 also describes a suitable method of forming a container or pouch for the cleaning composition.

Conveniently the two webs are non-wovens. Processes for manufacturing nonwoven fabrics can be grouped into four general categories leading to four main types of nonwoven products: textile-related, paper-related, extrusion-polymer processing related and hybrid combinations.

Textiles. Textile technologies include garneting, carding, and aerodynamic forming of fibres into selectively oriented webs. Fabrics produced by these systems are referred to as drylaid nonwovens, and they carry terms such as garneted, carded, and airlaid fabrics. Textile-based nonwoven fabrics, or fibre-network structures, are manufactured with machinery designed to manipulate textile fibres in the dry state. Also included in this category are structures formed with filament bundles or tow, and fabrics composed of staple fibres and stitching threads.

In general, textile-technology based processes provide maximum product versatility, since most textile fibres and bonding systems can be utilised.

Paper. Paper-based technologies include drylaid pulp and wetlaid (modified paper) systems designed to accommodate short synthetic fibres, as well as wood pulp fibres. Fabrics produced by these systems are referred to as drylaid pulp and wetlaid nonwovens. Paper-based nonwoven fabrics are manufactured with machinery designed to manipulate short fibres suspended in fluid.

Extrusions. Extrusions include spunbond, meltblown, and porous film systems. Fabrics produced by these systems are referred to individually as spunbonded, meltblown, and textured or apertured film nonwovens, or generically as polymer-laid nonwovens. Extrusion-based nonwovens are manufactured with machinery associated with polymer extrusion. In polymer-laid systems, fibre structures simultaneously are formed and manipulated.

Hybrids. Hybrids include fabric/sheet combining systems, combination systems, and composite systems. Combining systems employ lamination technology or at least one basic nonwoven web formation or consolidation technology to join two or more fabric substrates. Combination systems utilize at least one fabric substrate. Composite systems integrate two or more basic nonwoven web formation technologies to produce web structures. Hybrid processes combine technology advantages for specific applications.

Suitable materials for forming the enclosing wall are paper or a polyolefin, such as polyethylene or polypropylene, or another polymer such as a polyester or polyamide. Suitably the enclosing wall comprises a water-permeable, water-insoluble web, preferably of one or a mixture of the above materials. The enclosing wall is preferably a woven or non-woven web. The materials making up the enclosing wall are preferably in the form of fibres.

The product preferably has an enclosing wall which has a roughened outer surface. The roughened outer surface may be provided by the wall being in the form of woven or non-woven fibres. The roughness of the surface depends on, for example, the diameter of the fibres. The roughened outer surface may also be provided by ensuring that an otherwise uniform outer wall has a surface texture. This could be provided, for example, by including particulate matter in the wall or by forming the wall in an appropriate manner. A roughened outer surface may provide a number of advantages. For example, it ensures that the product is less likely to slip out of a consumer's hand, particularly when the product is damp and hence slippery. It also assists the pretreatment of the laundry item before it is washed. The product may simply be contacted with, for example rubbed on, a soil on a laundry item to treat the laundry item before washing, in particular to remove a soil or assist in soil removal. Some of the cleaning composition from inside the product may leach outside to assist in this pre-treatment. It is also possible for an additional agent to be attached to the outside of the product.

The enclosing wall may be formed of a cellular plastics material. Suitable cellular plastics materials for enclosing the powder composition include those with a density of between 1 and 500 kg/m³, preferably between 20 and 80 kg/m³, and with an average pore diameter of at least 0.1 mm, preferably at least 0.4 mm. Ideally, the cellular plastics material has a porosity of >50%, >60%, >70% or >80%.

The “porosity” according to the embodiment is obtained by measuring with a dry automatic densimeter an apparent volume and a true volume of the cellular plastic material, and calculated in accordance with the following equation.

Porosity %=[apparent volume-true volume)/apparent volume]×100

The “average pore diameter” is a value measured in accordance with ASTM (Designation: D4404-84) and is specifically a value determined by the measurement of the diameter of pores in accordance with a mercury penetration process using a mercury porosimeter manufactured by Porous Material, Inc.

Suitable cellular plastics are those readily available for example from Euro foam, Miarka and Menshen and are made from any suitable water-insoluble plastic such as cellulose, polyurethane, polyester, polyether, or blends thereof.

The surface wall or cellular plastic material enclosing the powder composition may be subjected to corona or plasma treatment. Both these treatments allow increasing the affinity of organic molecules, such as soil, to the substrate through ionic or polar interaction. By doing this the free soil molecules in the wash liquor are captured by the wall of the container which work as a filter, reducing the soil re-deposition on fabrics.

The cleaning product of the present invention may, for example, be such that, after it has been contacted with water in a ware washing machine, more than 20% wt of the composition remains. This is with reference to the product placed in the drum of a standard laundry washing machine, such as a Bosch WFR 3240 washing machine, at a standard washing cycle, in particular a cotton cycle at 60° C., and at any water hardness, but preferably at a water hardness of 18 to 24° dH (German degrees). Preferably, less than 20% wt, preferably less than 10% wt, and most preferably less than 5% wt, of the composition remains. Preferably a Bosch WFR 3240 laundry washing machine is used at a cotton cycle at 60° C. and at a water hardness of 18° dH. For the avoidance of doubt, even though this test uses a particular laundry washing machine, the water softening product of the present invention can be used in any laundry washing machine at any cycle. If the product meets the above test, it is capable of being used in any laundry machine at any cycle.

The product contains surfactants or mixtures thereof which is capable of being washed away. Inside the sachet, a binder may also be present which has the function of gluing the cleaning composition to the enclosing wall. This allows the composition to be distributed uniformly.

Surfactants may be present in the composition in an amount of, for example, 0.01 to 50% wt, ideally 0.1 to 30% wt and preferably 0.5 to 10% wt. The surfactant is, for example, an anionic or nonionic surfactant or mixture thereof. The nonionic surfactant is preferably a surfactant having a formula RO (CH₂CH₂O)ₙH wherein R is a mixture of linear, even carbon-number hydrocarbon chains ranging from C₁₂H₂₅ to C₁₆H₃₃ and n represents the number of repeating units and is a number of from about 1 to about 12. Examples of other non-ionic surfactants include higher aliphatic primary alcohol containing about twelve to about 16 carbon atoms which are condensed with about three to thirteen moles of ethylene oxide per mole of alcohol (i.e. three to thirteen equivalents).

Other examples of nonionic surfactants include primary alcohol ethoxylates (available under the Neodol tradename from Shell Co.), such as C₁₁ alkanol condensed with 9 equivalents of ethylene oxide (Neodol 1-9), CO₂-13 alkanol condensed with 6.5 equivalents ethylene oxide (Neodol 23-6.5), C₁₂₋₁₃ alkanol with 9 equivalents of ethylene oxide (Neodol 23-9), C₁₂₋₁₅ alkanol condensed with 7 or 3 equivalents ethylene oxide (Neodol 25-7 or Neodol 25-3), C₁₄₋₁₅ alkanol condensed with 13 equivalents ethylene oxide (Neodol 45-13), C₉₋₁₁ linear ethoxylated alcohol, averaging 2.5 equivalents of ethylene oxide per mole of alcohol (Neodol 91-2.5), and the like.

Other examples of nonionic surfactants suitable for use in the present invention include ethylene oxide condensate products of secondary aliphatic alcohols containing 11 to 18 carbon atoms in a straight or branched chain configuration condensed with 5 to 30 equivalents of ethylene oxide. Examples of commercially available non-ionic detergents of the foregoing type are C₁₁₋₁₅ secondary alkanol condensed with either 9 equivalents of ethylene oxide (Tergitol 15-S-9) or 12 equivalents of ethylene oxide (Tergitol 15-S-12) marketed by Union Carbide, a subsidiary of Dow Chemical.

Octylphenoxy polyethoxyethanol type nonionic surfactants, for example, Triton X-100, as well as amine oxides can also be used as a nonionic surfactant in the present invention.

Other examples of linear primary alcohol ethoxylates are available under the Tomadol tradename such as, for example, Tomadol 1-7, a C₁₁ linear primary alcohol ethoxylate with 7 moles EO; Tomadol 25-7, a C₁₂₋₁₅ linear primary alcohol ethoxylate with 7 moles EO; Tomadol 45-7, a C₁₄₋₁₅ linear primary alcohol ethoxylate with 7 equivalents EO; and Tomadol 91-6, a C₉₋₁₁ linear alcohol ethoxylate with 6 equivalents EO.

Other nonionic surfactants are amine oxides, alkyl amide oxide surfactants.

Preferred anionic surfactants are frequently provided as alkali metal salts, ammonium salts, amine salts, aminoalcohol salts or magnesium salts. Contemplated as useful are one or more sulfate or sulfonate compounds including: alkyl benzene sulfates, alkyl sulfates, alkyl ether sulfates, alkylamidoether sulfates, alkylaryl polyether sulfates, monoglyceride sulfates, alkylsulfonates, alkylamide sulfonates, alkylarylsulfonates, olefinsulfonates, paraffin sulfonates, alkyl sulfosuccinates, alkyl ether sulfosuccinates, alkylamide sulfosuccinates, alkyl sulfosuccinamate, alkyl sulfoacetates, alkyl phosphates, alkyl ether phosphates, acyl sarconsinates, acyl isethionates, and N-acyl taurates. Generally, the alkyl or acyl radical in these various compounds comprise a carbon chain containing 12 to 20 carbon atoms.

Other surfactants which may be used are alkyl naphthalene sulfonates and oleoyl sarcosinates and mixtures thereof.

Examples of suitable bleaches are oxygen bleaches. Oxygen bleaches may be used in the range of from 0.01 to 80% wt, preferably of 0.1 from 70% wt, ideally 1 to 60% wt. As used herein active oxygen concentration refers to the percentage concentration of elemental oxygen, with an oxidation number zero, that being reduced to water would be stoichiometrically equivalent to a given percentage concentration of a given peroxide compound, when the peroxide functionality of the peroxide compound is completely reduced to oxides. The active oxygen sources increase the ability of the compositions to remove oxidisable soils, to destroy malodorous molecules and to kill germs.

The concentration of available oxygen can be determined by methods known in the art, such as the iodimetric method, the permanganometric method and the cerimetric method. Said methods and the criteria for the choice of the appropriate method are described for example in “Hydrogen Peroxide”, W. C. Schumo, C. N. Satterfield and R. L. Wentworth, Reinhold Publishing Corporation, New York, 1955 and “Organic Peroxides”, Daniel Swern, Editor Wiley Int. Science, 1970.

Suitable organic and inorganic peroxides for use in the compositions according to the present invention include diacyl and dialkyl peroxides such as dibenzoyl peroxide, dilauroyl peroxide, dicumyl peroxide, persulphuric acid and mixtures thereof.

Bleaches may be provided as already formed bleaches or as bleach precursors; both are within the scope of the present invention.

Suitable preformed bleaches for use in the compositions of the present invention are preformed peroxyacids, for example diperoxydodecandioic acid DPDA, magnesium perphthalatic acid, perlauric acid, perbenzoic acid, diperoxyazelaic acid and mixtures thereof. Peroxygen bleaching actives useful for this invention are: percarbonates, perborates, peroxides, peroxyhydrates, persulfates. A preferred compound is sodium percarbonate and especially the coated grades that have better stability. The percarbonate can be coated with silicates, borates, waxes, sodium sulfate, sodium carbonate and surfactants solid at room temperature.

Suitable bleach precursors for use in compositions of the present invention may include peracid precursors, i.e. compounds that upon reaction with hydrogen peroxide product peroxyacids. Examples of peracid precursors suitable for use in the present invention can be found among the classes of anhydrides, amides, imides and esters such as acetyl triethyl citrate (ATC), tetra acetyl ethylene diamine (TAED), succinic or maleic anhydrides. A bleach precursor may suitably be present in an amount of from 0.01 to 30% wt, preferably 2 to 20% wt.

The composition may, for example, comprise at least one builder or a combination of them, for example in an amount of from 0.01 to 80% wt, preferably from 0.1 to 50% wt. Builders of present invention may be used as chelating agents for metals, water softening agents, anti-redeposition agents and/or sources of alkalinity.

Examples of builders are described below:
the parent acids of the monomeric or oligomeric polycarboxylate chelating agents or mixtures thereof with their salts, e.g. citric acid or citrate/citric acid mixtures are also contemplated as useful builder components.

borate builders, as well as builders containing borate-forming materials than can produce borate under detergent storage or wash conditions can also be used.

iminosuccinic acid metal salts.

polyaspartic acid metal salts.

ethylene diamino tetra acetic acid and salt forms.

water-soluble phosphonate and phosphate builders are useful for this invention. Examples of phosphate builders are the alkali metal tripolyphosphates, sodium, potassium and ammonium pyrophosphate, sodium and potassium and ammonium pyrophosphate, sodium and potassium orthophosphate sodium polymeta/phosphate in which the degree of polymerisation ranges from 6 to 21, and salts of phytic acid. Specific examples of water-soluble phosphate builders are the alkali metal tripolyphosphates, sodium, potassium and ammonium pyrophosphate, sodium, potassium and ammonium pyrophosphate, sodium and potassium orthophosphate, sodium polymeta/phosphate in which the degree of polymerization ranges from 6 to 21, and salts of phytic acid. Such polymers include the polycarboxylates containing two carboxy groups, include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates.

Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447.

Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936,448, and the sulfonated pyrolysed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

Suitable polymer water-soluble compounds include the water soluble monomeric polycarboxylates, or their acid forms, homo or copolymeric polycarboxylic acids or their salts in which the polycarboxylic acid comprises at least two carboxylic radicals separated from each other by not more than two carbon atoms, carbonates, bicarbonates, borates, phosphates, and mixtures of any of the foregoing.

The carboxylate or polycarboxylate builder can be monomeric or oligomeric in type although monomeric polycarboxylates are generally preferred for reasons of cost and performance.

Suitable carboxylates containing one carboxy group include the water soluble salts of lactic acid, glycolic acid and ether derivatives thereof. Polycarboxylates containing two carboxy groups include the water-soluble salts of succinic acid, malonic acid, (ethylenedioxy) diacetic acid, maleic acid, diglycolic acid, tartaric acid, tartronic acid and fumaric acid, as well as the ether carboxylates and the sulfinyl carboxylates. Polycarboxylates containing three carboxy groups include, in particular, water-soluble citrates, aconitrates and citraconates as well as succinate derivates such as the carboxymethloxysuccinates described in GB-A-1,379,241, lactoxysuccinates described in GB-A-1,389,732, and aminosuccinates described in NL-A-7205873, and the oxypolycarboxylate materials such as 2-oxa-1,1,3-propane tricarboxylates described in GB-A-1,387,447. Polycarboxylate containing four carboxy groups include oxydisuccinates disclosed in GB-A-1,261,829, 1,1,2,2-ethane tetracarboxylates, 1,1,3,3-propane tetracarboxylates and 1,1,2,3-propane tetracarobyxlates. Polycarboxylates containing sulfo substituents include the sulfosuccinate derivatives disclosed in GB-A-1,398,421, GB-A-1,398,422 and U.S. Pat. No. 3,936,448, and the sulfonated pyrolysed citrates described in GB-A-1,439,000.

Alicylic and heterocyclic polycarboxylates include cyclopentane-cis,cis,cis-tetracarboxylates, cyclopentadienide pentacarboxylates, 2,3,4,5,6-hexane-hexacarboxylates and carboxymethyl derivates of polyhydric alcohols such as sorbitol, mannitol and xylitol. Aromatic polycarboxylates include mellitic acid, pyromellitic acid and the phthalic acid derivatives disclosed in GB-A-1,425,343.

Of the above, the preferred polycarboxylates are hydroxycarboxylates containing up to three carboxy groups per molecule, more particularly citrates.

More preferred polymers are homopolymers, copolymers and multiple polymers of acrylic, fluorinated acrylic, sulfonated styrene, maleic anhydride, metacrylic, iso-butylene, styrene and ester monomers.

Examples of these polymers are Acusol supplied from Rohm & Haas, Syntran supplied from Interpolymer and the Versa and Alcosperse series supplied from Alco Chemical, a National Starch & Chemical Company.

The parent acids of the monomeric or oligomeric polycarboxylate chelating agents or mixtures thereof with their salts, e.g. citric acid or citrate/citric acid mixtures are also contemplated as useful builder components.

Examples of bicarbonate and carbonate builders are the alkaline earth and the alkali metal carbonates, including sodium and calcium carbonate and sesqui-carbonate and mixtures thereof. Other examples of carbonate type builders are the metal carboxy glycine and metal glycine carbonates.

In the context of the present application it will be appreciated that builders are compounds that sequester metal ions associated with the hardness of water, e.g. calcium and magnesium, whereas chelating agents are compounds that sequester transition metal ions capable of catalysing the degradation of oxygen bleach systems. However, certain compounds may have the ability to do perform both functions.

Suitable chelating agents to be used herein include chelating agents selected from the group of phosphonate chelating agents, amino carboxylate chelating agents, polyfunctionally-substituted aromatic chelating agents, and further chelating agents like glycine, salicylic acid, aspartic acid, glutamic acid, malonic acid, or mixtures thereof. Chelating agents when used, are typically present herein in amounts ranging from 0.01 to 50% wt of the total composition and preferably from 0.05 to 10% wt.

Suitable phosphonate chelating agents to be used herein may include ethydronic acid as well as amino phosphonate compounds, including amino alkylene poly (alkylene phosphonate), alkali metal ethane 1-hydroxy diphosphonates, nitrilo trimethylene phosphonates, ethylene diamine tetra methylene phosphonates, and diethylene triamine penta methylene phosphonates. The phosphonate compounds may be present either in their acid form or as salts of different cations on some or all of their acid functionalities. Preferred phosphonate chelating agents to be used herein are diethylene triamine penta methylene phosphonates. Such phosphonate chelating agents are commercially available from Monsanto under the trade name DEQUEST™.

Polyfunctionally-substituted aromatic chelating agents may also be useful in the compositions herein. See U.S. Pat. No. 3,812,044, issued May 21, 1974, to Connor et al. Preferred compounds of this type in acid form are dihydroxydisulfobenzenes such as 1,2-dihydroxy-3,5-disulfobenzene.

A preferred biodegradable chelating agent for use herein is ethylene diamine N,N′-disuccinic acid, or alkali metal, or alkaline earth, ammonium or substituted ammonium salts thereof or mixtures thereof. Ethylenediamine N,N′-disuccinic acids, especially the (S,S) isomer have been extensively described in U.S. Pat. No. 4,704,233, Nov. 3, 1987, to Hartman and Perkins. Ethylenediamine N,N′-disuccinic acids is, for instance, commercially available under the tradename ssEDDS™ from Palmer Research Laboratories.

Suitable amino carboxylates to be used herein include ethylene diamine tetra acetates, diethylene triamine pentaacetates, diethylene triamine pentaacetate (DTPA), N-hydroxyethylethylenediamine triacetates, nitrilotri-acetates, ethylenediamine tetrapropionates, triethylenetetraaminehexa-acetates, ethanol-diglycines, propylene diamine tetracetic acid (PDTA) and methyl glycine diacetic acid (MGDA), both in their acid form, or in their alkali metal, ammonium, and substituted ammonium salt forms. Particularly suitable amino carboxylates to be used herein are diethylene triamine penta acetic acid, propylene diamine tetracetic acid (PDTA) which is, for instance, commercially available from BASF under the trade name Trilon FS™ and methyl glycine di-acetic acid (MGDA).

The cleaning compositions may also comprise fillers. Examples of fillers are sodium chloride, bentonite, zeolites, citrates, talc and metal sulfate salts such as sodium, calcium and aluminium sulfates. They can be used at a level from 0.01 to 60% wt, preferably between 0.1 and 30% wt.

Solvents can be used in the composition of the present invention at levels from 0.01 to 30% wt, preferably from 0.1 to 3% wt. The solvent constituent may include one or more alcohol, glycol, acetate, ether acetate, glycerol, polyethylene glycol with molecular weight ranging from 200 to 1000, silicones or glycol ethers. Exemplary alcohols useful in the compositions of the invention include C2-C8 primary and secondary alcohols which may be straight chained or branched, preferably pentanol and hexanol.

Preferred solvents for the invention are glycol ethers and examples include those glycol ethers having the general structure R^{a}—O—[CH₂—CH(R)—(CH₂)—0]ₙ—H, wherein R^{a} is C₁₋₂₀ alkyl or alkenyl, or a cyclic alkane group of at least 6 carbon atoms, which may be fully or partially unsaturated or aromatic; n is an integer from 1 to 10, preferably from 1 to 5; and each R is selected from H or CH₃. Specific and preferred solvents are selected from propylene glycol methyl ether, dipropylene glycol methyl ether, tripropylene glycol methyl ether, propylene glycol n-propyl ether, ethylene glycol n-butyl ether, diethylene glycol n-butyl ether, diethylene glycol methyl ether, propylene glycol, ethylene glycol, isopropanol, ethanol, methanol, diethylene glycol monoethyl ether acetate, and, especially, propylene glycol phenyl ether, ethylene glycol hexyl ether and diethylene glycol hexyl ether.

The composition may, for example, comprise one enzyme or a combination of them, for example in an amount of from 0.01 to 10% wt, preferably from 0.1 to 2% wt. Enzymes in granular form are preferred. Example of enzymes are proteases, modified proteases stable in oxidisable conditions, amylases, lipases and cellulases.

Preferably, the water-insoluble soil catcher compound would comprise a solid cross-linked polyvinyl N-oxide, as discussed more fully hereafter. Products made in accordance with the present invention which are suitable for use individually can be provided in a variety forms, but will at least contain a compartment for storing a water-insoluble soil catcher compound and have a plurality of apertures, as previously described.

The laundry devices of the present invention can be used with a variety of water-insoluble soil catcher compounds that may be retained inside the product before during and after use. These water-insoluble soil catcher compounds can be provided as a solid, gel, and the like. These soil catcher compounds can deliver the soil catcher benefit by a variety of techniques, including, but not limited to trapping the soil in such a manner that it is unavailable for re-deposition onto a fabric, precipitating out the soil or adsorbing, absorbing or otherwise becoming associated with any extraneous soil in the wash water. As used herein, the phrase “substantially water insoluble” is intended to mean that the soil catcher compound has a solubility in deionised water at 20° C. of less than about 1 gm/litre. A substantially water insoluble soil catcher compound may comprise a water-soluble soil catcher agent which is bound to a water insoluble carrier, or it may comprise a soil catcher agent which in itself is water insoluble. Water insoluble carriers for water-soluble polymeric agents include inorganic materials such as zeolites, clays such as kaolinites, smectites, hectorite types, silicas (or other detergent ingredients). Additionally, organic water-insoluble materials such as fatty alcohols, esters of fatty acids, or polysaccharides that can form water-insoluble gels upon hydration (e.g. gellan gum, carrageenan gum, agarose etc.) can be used as carriers herein. For the soil catcher agents which are themselves water insoluble, water insolubility can be achieved by cross-linking, either starting from the known water-soluble soil catcher polymeric agents, or starting from monomers of these polymers. Other compounds that are suitable as water insoluble soil catcher agents are any compound exhibiting ion exchange properties, preferably anion exchangers. For instance, non-limiting examples of such products are Dowex® exchange resins of the Dow Chemical Co. or equivalent from other suppliers; Sephadex®, Sepharose® or Sephacel® exchange resins all from Pharmacia Biotech; any other polysaccharide having ion exchange properties such as modified cellulosics, starches; other derivatives of the wood industry such as wood pulp or lignin.

Water soluble polymeric soil catcher agents that are suitable to be bound to insoluble carriers, or to be made insoluble via cross-linking are those polymers known in the art to inhibit the transfer of dyes from coloured fabrics onto fabrics washed therewith. These polymers have the ability to complex or adsorb the fugitive dyes washed out of dyed fabrics before the dyes have the opportunity to become attached to other articles in the wash. Especially suitable polymeric soil catcher agents are polyamine N-oxide polymers, polymers and copolymers of N-vinylpyrrolidone and N-vinylimidazole, vinyloxazolidones, vinylpyridine, vinylpyridine N-oxide, other vinylpyridine derivatives or mixtures thereof.

### a) Polyamine N-Oxide Polymers

The polyamine N-oxide polymers suitable for use contain units having the following structure formula:

P-Aₓ-R—N—O

wherein P is a polymerisable unit, wherein the R—N—O group can be attached to, when x is 0, or wherein the R—N—O group forms part of the polymerisable unit or a combination of both;

A is —C(0)0-, -0C(0)-, —C(0)-, -0-, —S—, —N—; and x is 0 or 1;

R are aliphatic, ethoxylated aliphatics, aromatic, heterocyclic or alicyclic groups or any combination thereof whereto the nitrogen of the N—O group can be attached or wherein the nitrogen of the N—O group is part of these groups.

The N—O group can be represented by the following general structures:

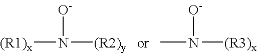

wherein R1, R2, and R3 are aliphatic groups, aromatic, heterocyclic or alicyclic groups or combinations thereof, x or/and y or/and z is 0 or 1 and wherein the nitrogen of the N—O group can be attached or wherein the nitrogen of the N—O group forms part of these groups.

The N—O group can be part of the polymerisable unit P or can be attached to the polymeric backbone or a combination of both.

Suitable polyamine N-oxides wherein the N—O group forms part of the polymerisable unit comprise polyamine N-oxides wherein R is selected from aliphatic, aromatic, alicyclic or heterocyclic groups. One class of said polyamine N-oxides comprises the group of polyamine N-oxides wherein the nitrogen of the N—O group forms part of the R-group. Preferred polyamine N-oxides are those wherein R is a heterocyclic group such as pyridine, pyrrole, imidazole, pyrrolidine, piperidine, quinoline, acridine and derivatives thereof. Another class of said polyamine N-oxides comprises the group of polyamine N-oxides wherein the nitrogen of the N—O group is attached to the R-group. Other suitable polyamine N-oxides are the polyamine oxides wherein the N—O group is attached to the polymerisable unit. Preferred classes of these polyamine N-oxides are the polyamine N-oxides having the general formula above wherein R is an aromatic, heterocyclic or alicyclic groups wherein the nitrogen of the N—O functional group is part of said R group. Examples of these classes are polyamine oxides wherein R is a heterocyclic compound such as pyridine, pyrrole, imidazole and derivatives thereof. Another preferred class of polyamine N-oxides is the polyamine oxides having the general formula above wherein R are aromatic, heterocyclic or alicyclic groups wherein the nitrogen of the N—O functional group is attached to said R groups. Examples of these classes are polyamine oxides wherein R groups can be aromatic such as phenyl.

Any polymer backbone can be used as long as the amine oxide polymer formed has soil catcher properties. Examples of suitable polymeric backbones are polyvinyls, polyalkylenes, polyesters, polyethers, polyamide, polyimides, polyacrylates and mixtures thereof. The amine N-oxide polymers of the present invention typically have a ratio of amine to the amine N-oxide of about 10:1 to about 1:1000000. However the amount of amine oxide groups present in the polyamine oxide polymer can be varied by appropriate copolymerisation or by appropriate degree of N-oxidation. Preferably, the ratio of amine to amine N-oxide is from about 2:3 to about 1:1000000. More preferably from about 1:4 to about 1:1000000, and most preferably from about 1:7 to about 1:1000000. The polymers of the present invention may encompass random or block copolymers where one monomer type is an amine N-oxide and the other monomer type is either an amine N-oxide or not. The amine oxide unit of the polyamine N-oxides has a pKa <10, preferably pKa <7, more preferred pKa <6. The polyamine oxides can be obtained in almost any degree of polymerisation. The degree of polymerisation is not critical provided the material has the desired dye-suspending power. Typically, the average molecular weight is within the range of about 500 to about 1,000,000; preferably from about 1,000 to about 50,000, more preferably from about 2,000 to about 30,000, and most preferably from about 3,000 to about 20,000.

### b) Copolymers of N-Vinylpyrrolidone and N-Vinylimidazole

The N-vinylimidazole N-vinylpyrrolidone polymers used in the present invention have an average molecular weight range from about 5,000 to about 1,000,000, preferably from about 5,000 to about 200,000. Highly preferred polymers for use in the laundry detergent compositions according to the present invention comprise a polymer selected from N-vinylimidazole N-vinylpyrrolidone copolymers wherein said polymer has an average molecular weight range from about 5,000 to about 50,000; more preferably from about 8,000 to about 30,000; and most preferably from about 10,000 to about 20,000. The average molecular weight range was determined by light scattering as described in Barth H. G. and Mays J. W. Chemical Analysis Vol 113, “Modern Methods of Polymer Characterisation”. Highly preferred N-vinylimidazole N-vinylpyrrolidone copolymers have an average molecular weight range from about 5,000 to about 50,000; more preferably from about 8,000 to about 30,000; most preferably from about 10,000 to about 20,000. The N-vinylimidazole N-vinylpyrrolidone copolymers characterised by having said average molecular weight range provide excellent soil catcher properties. The N-vinylimidazole N-vinylpyrrolidone copolymer of the present invention has a molar ratio of N-vinylimidazole to N-vinylpyrrolidone from about 1 to about 0.2, more preferably from about 0.8 to about 0.3, and most preferably from about 0.6 to about 0.4

### c) Polyvinylpyrrolidone

Polyvinylpyrrolidone (“PVP”) having an average molecular weight from about 2,500 to about 400,000 can also be utilised; preferably of average molecular weight from about 5,000 to about 200,000; more preferably from about 5,000 to about 50,000; and most preferably from about 5,000 to about 15,000. Suitable polyvinylpyrrolidones are commercially available from ISP Corporation, New York, N.Y. and Montreal, Canada under the product names PVP K-15 (viscosity molecular weight of 10,000), PVP K-30 (average molecular weight of 40,000), PVP K-60 (average molecular weight of 160,000), and PVP K-90 (average molecular weight of 360,000). Other suitable polyvinylpyrrolidones which are commercially available from BASF include Sokalan HP 165 and Sokalan HP 12; polyvinylpyrrolidones known to persons skilled in the detergent field (see for example EP-A-262,897 and EP-A-256,696).

### d) Polyvinyloxazolidone

One may also utilise polyvinyloxazolidone as a polymeric soil catcher agent. Said polyvinyloxazolidones have an average molecular weight from about 2,500 to about 400,000; preferably from about 5,000 to about 200,000; more preferably from about 5,000 to about 50,000; and most preferably from about 5,000 to about 15,000.

### e) Polyvinylimidazole

One may also utilise polyvinylimidazole as polymeric soil catcher agent. Said polyvinylimidazoles have an average molecular weight from about 2,500 to about 400,000; preferably from about 5,000 to about 200,000; more preferably from about 5,000 to about 50,000; and most preferably from about 5,000 to about 15,000.

### f) Cationic Polymers

Such polymers are those having a cationic group into their polymeric backbone, as shown by the formula:

[P-Catₓ]ₙ-Zₜ-Cat_{y}

Wherein P represents polymerisable units, Z represents an alkyl, aryl, carbonyl, ester, ether, amide or amine group, Cat represents cationic groups, preferably including quaternised N groups or other cationic units, x=0 or 1, y=0 or 1, t=0 or 1. Preferred cationic polymers are quaternised polyvinylpyridines.

Water insolubility can, in the case of non-cross linked polymers, also be achieved by selecting very high molecular weight range, or by copolymerising, or by varying the degree of oxidation if appropriate, depending on the polymer. Polymers which are water soluble, such as those described in U.S. Pat. No. 5,912,221, may be made insoluble if the molecular weight is increased above 400,000.

### g) Cross-Linked Polymers

Cross-linked polymers are polymers whose backbones are interconnected to a certain degree; these links can be of chemical or physical nature, possibly with active groups on the backbone or on branches; cross-linked polymers have been described in the Journal of Polymer Science, volume 22, pages 1035-1039. In one embodiment, the cross-linked polymers are made in such a way that they form a three-dimensional rigid structure, which can entrap dyes in the pores formed by the three-dimensional structure. In another embodiment, the cross-linked polymers entrap the dyes by swelling. Such cross-linked polymers are described in U.S. Pat. No. 5,912,221.

Thus, a cross-linked polymer has one or more individual molecular chains linked by side branches to adjacent chains. The cross-links can be formed: (a) between already existing linear or branched polymers, (b) during the polymerisation of multi-functional monomers, or (c) during the polymerisation of dimeric monomers with traces of multi-functional monomers. The cross-linking can also be achieved by various means known in the art. For instance, the cross-links can be formed using radiation, oxidation and curing agents, such as divinylbenzene, epichlorohydrin and the like. Preferably, cross-linked polymers for the purpose of this invention are those obtained by cross-linking a water-soluble soil catcher polymer described above with divinylbenzene (DVB) cross-linking agent during polymerisation of the soil catcher monomer. Cross-linking degree can be controlled by adjusting the amount of divinylbenzene (DVB) cross-linking agent. Preferably, the degree of cross-linking is between about 0.05% wt of DVB over soil catcher monomer and about S0% wt of DVB over soil catcher monomer and, more preferably, between about 0.05% wt of DVB over soil catcher monomer and about 25% wt of DVB over soil catcher monomer. Most preferably, the degree of cross-linking is between about 0.1% wt of DVB over soil catcher monomer and about 5% wt of DVB over soil catcher monomer. The cross linking forms soil catcher compound particles, at least 90% of which by total weight of particles (and more preferably at least about 95% wt) have a d₅₀ particle size of at least about 1 μm, preferably at least about 50 μm, and more preferably at least about 75 μm, all as measured in their dry state. Most preferably, the cross linking forms soil catcher compounds, at least 90% (and more preferably at least about 95%) of which have a d₅₀ particle size of between about 1 μm and about 5 mm, still more preferably between about 50 μm and about 2500 μm, and yet still more preferably between about 75 μm and about 1500 μm, all as measured in their dry state. Preferably, the cross-linked polymer is a polyamine N-oxide or a quaternised polyamine. The person skilled in the art may conveniently obtain such compounds by oxidising or quaternizing cross-linked polyvinylpyridines from Reilly Industries Inc. commercialised under the name Reillex™ 402 or Reillex™425 by methods known in the art. For instance, but not exclusively, the method described in U.S. Pat. No. 5,458,809 can be used to prepare a polyamine N-oxide of interest from the commercially available compounds given above. An example of quaternised polyamine can also be obtained from Reilly Industries under the commercial name Reillex™ HPQ.

Additional, optional, ingredients, selected from a list consisting of fragrance, anticaking agent as sodium xylene sulfonate and magnesium sulfate, dye, may be present at levels of up to 5% wt, preferably less then 1% wt.

Examples of optional binders for example in an amount of from 0.1 to 50% wt, preferably from 1 to 30% wt are non soluble systems such as APP, SBS, SEBS, SIS, EVA and soluble systems such as polyethylene glycol with molecular weight ranging from 1000 to 10000. The binders are pre-mixed with cleaning composition, filled in the cleaning container and hot melted through a compression process involving a heat or ultrasound process. The mechanical and thermal stress has to be limited in order to avoid solid oxygen bleach raw materials decomposition as well as degradation of other sensible ingredients for example enzymes.

The enclosing wall may be coated with a water-soluble component, such as a water-soluble polymer, for example a poly(vinyl alcohol).

In accordance with a second aspect of the present invention there is provided a multipurpose product containing active agent(s) for cleaning a soil on a laundry item by any one of:
contacting the soil with a laundry cleaning product before washing,
adding the laundry cleaning product directly into the drum of a washing machine to achieve the release of the active agent(s) during the wash cycle
adding the laundry cleaning product in a bucket with water and laundry and soaking for an interval;
   wherein said laundry cleaning product has an enclosing wall and contains a cleaning composition, preferably in the form of a powder, comprising an active agent selected from the group consisting of a surfactant, a bleach or a mixture thereof, the wall being permeable to water and to components dissolved therein.

1. A method for treating a soil on a laundry item before it is washed, which comprises contacting the soil with a laundry cleaning product having an enclosing wall and containing a cleaning composition, preferably in the form of a powder, said composition comprising an active agent selected from the group consisting of a surfactant, a bleach or a mixture thereof, the wall being permeable to water and to components dissolved therein.

2. A method according to claim 1 wherein the laundry cleaning product is rubbed on the soil.

3. A method according to claim 1 wherein the laundry cleaning product is moistened before contacting the soil.

4. A method according to claim 1 wherein the surfactant comprises an anionic or nonionic surfactant or a mixture thereof.

5. A method according to claim 1 wherein the bleach is an oxygen bleach or a precursor therefor.

6. A method according to claim 5 wherein the bleach is a percarbonate.

7. A method according to claim 1 wherein the enclosing wall comprises a water-permeable, water-insoluble web.

8. A method according to claim 1 wherein one side of the container is a water-permeable, water-insoluble wall and the other side is a water impermeable wall which allows hand contact with the composition to be avoided in the method.

9. A method according to claim 1 wherein the enclosing wall has a roughened outer surface.

10. A method according to claim 8 wherein the enclosing wall is a non-woven web.

11. A method according to claim 8 wherein the wall is formed from a polyolefin, polyester or polyamide.

12. A method according to claim 1 wherein the enclosing wall is coated with a water-soluble component.

13. A method according to claim 13 wherein the water soluble component comprises a poly(vinyl alcohol).

14. A method according to claim 1 wherein the cleaning composition comprises a water-soluble portion which leaves the laundry cleaning product and a water-insoluble portion which remains within the laundry cleaning product.

15. A method according to claim 1 wherein, after the laundry cleaning product has been contacted with water in a laundry washing machine in a wash cycle, less than 20% wt of the composition remains.

16. A method according to claim 1 which further comprises adding the laundry cleaning product and laundry comprising the laundry item and optionally further laundry to a washing machine and conducting the wash.

17. A process for treating a laundry item which comprises the steps of:
providing a multipurpose product containing active agent(s) for cleaning a soil on a laundry item by any one of:
(a) contacting the soil with a laundry cleaning product before washing,
(b) adding the laundry cleaning product directly into the drum of a washing machine to achieve the release of the active agent(s) during the wash cycle
(c) adding the laundry cleaning product in a bucket with water and laundry and soaking for an interval;
wherein said laundry cleaning product has an enclosing wall and contains a cleaning composition, preferably in the form of a powder, comprising an active agent selected from the group consisting of a surfactant, a bleach or a mixture thereof, the wall being permeable to water and to components dissolved therein.
